(19) United States
(12) Patent Application Publication
(10) Pub. No.: US 2003/0157409 A1
(43) Pub. Date: Aug. 21, 2003

(54) Polymer lithium battery with ionic electrolyte

(76) Inventor: Sui-Yang Huang, Pleasanton, CA (US)

Correspondence Address: Otto O. Lee, Suite 1205, 12 South First Street, San Jose, CA, 95113, US

(21) Appl. No.: 10/368,926

(22) Filed: Feb. 18, 2003

Related U.S. Application Data
(60) Provisional application No. 60/358,593, filed on Feb. 21, 2002.

(51) Int. Cl. H01M 10/40; H01M 4/58; H01M 4/62; H01M 4/66; H01M 4/50; H01M 4/52

(52) U.S. Cl. 429/306; 429/231.8; 429/217; 429/245; 429/231.95; 429/223; 429/224; 429/231.1

(57) ABSTRACT

There is disclosed a novel rechargeable lithium battery with ionic electrolyte. The embodiments for the new polymer lithium ion batteries in the present invention comprise three major components, each of which is a composite: an anode, a cathode, and a polymer-gel-electrolyte-separator system. The anode consists of a lithium ion host such as graphite as active materials. The cathode is a mixture of lithium compounds, high surface area carbon and sometimes a catalyst. The polymer-gel-electrolyte-separator system comprises inorganic electrolyte as active material, which is immobilized in the polymer matrix. Two chemistries involved in these embodiments of batteries include intercalation of lithium ions and catalyzed electrolysis of lithium compounds.

### CROSS REFERENCE

This application claims benefit of U.S. Provisional Application No. 60/358,593, filed Feb. 21, 2002, which is hereby incorporated herein by reference.

### BACKGROUND OF THE INVENTION

In the past decade, the increasingly mobile workforce throughout the world has stimulated an increased demand for portable consumer electronics such as cellular phones, laptop computers, PDAs, digital cameras, digital camcorders, etc. In addition, rechargeable power tools have become more popular because of their cordless convenience and electric vehicles (EVs) have become more attractive because of their environmental advantages such as zero emissions and low noise. With the increasing reliance and demand for rechargeable devices, the consumer is demanding more dependable and longer-lasting equipment, both of which are determined by the performance of the battery that fuels the mobile devices.

Rechargeable batteries for powering portable electronics have evolved over three generations, from Ni—Cd to Ni—MH and then Li-ion batteries. The gravimetric energy density for each new generation has increased 50-100% by forming batteries with innovative combinations of chemistry, materials and technology. Today, the lithium ion battery dominates the majority of consumer markets and is projected to show an impressive 40% compound annual growth rate for at least the next five years. Rechargeable batteries for powering portable tools and electric vehicles have evolved over two generations, from Ni—Cd to Ni—MH for portable tools and from lead-acid to Ni—MH for EV applications, respectively. However, current lithium ion batteries are too expensive for widespread use in these areas.

Attempts to further improve lithium ion batteries are hampered by limitations from their cathodes. The active materials in the anode have been approaching their theoretical capacity of 372 Ah/kg. However, the active materials LiNi_{0.8}Co_{0.2}O₂ and LiCoO₂, used in the cathode of many commercial batteries, have achieved only 200 Ah/kg and 150 Ah/kg, respectively. Further increase of their capacity requires a deeper delithiation of the compounds. However, deeper delithiation of these compounds has the serious drawback of seriously damaging the materials, causing safety concerns such as thermal run-a-way and explosion. Economically, the energy cost (US dollars per watt-hour) of lithium ion batteries is more than 20% higher than that of other mobile power sources.

Ionic electrolytes have been employed in lithium primary batteries since 1960. Typical battery chemistries are Li/SO₂/C, Li/SOCl₂/C and Li/SO₂Cl₂/C. All of these non-rechargeable battery systems employ metallic lithium foil as the anode and high surface area carbon black in the cathode. The electrolyte is an inorganic liquid such as sulfur dioxide, thionyl chloride, or sulfuryl chloride and LiAlCl₄ as a salt. These inorganic compounds are referred to as the soluble cathode because they serve as both the solvent and the active cathode materials. These batteries are advantageous because of their high energy density, high power density, low cost, and safety features. The energy density output of these batteries is among the highest energy density battery systems, reaching 250-500 Wh/kg as gravimetric energy density and 500-1000 Wh/L as volumetric energy density, respectively. The batteries are able to deliver their energy at high current and power levels due to superior ionic conductivity of inorganic electrolytes with a magnitude of 10⁻¹S/cm, which is 100 times better than most organic electrolytes. Finally, all of the materials used to produce the battery are readily available. These batteries have been applied in many commercial and military areas from portable equipment to stationary systems. They also come in a variety of sizes, from 0.005 Ah to 20,000 Ah, and configurations, ranging from small coin cells and cylindrical cells to large prismatic batteries.

The superior performance, safety, and cost features of lithium primary batteries have led to a number of attempts to convert these primary batteries into secondary (rechargeable) systems since the late 1980s. The Li/SOCl₂/C battery could not be recharged due to formation of a free sulfur layer, which is deposited as discharge product on the cathode and is insoluble to the electrolyte. The references cited propose to slightly modify Li/SO₂/C and Li/SO₂Cl₂/C batteries to discharge and recharge for 50-200 cycles to 50% initial capacity.

Unfortunately, attempts by the prior art to create rechargeable Li/SO₂/C and Li/SO₂Cl₂/C batteries have several disadvantages. Such batteries show a poor rechargeability. The main cause of this problem may be due to employment of metallic lithium foil as the anode. A lithium dendrite could form on the surface of lithium anode during the recharging process and as it increases in size it might eventually penetrate the separator, causing an electric short between the anode and the cathode. This internal short stimulates a self-discharge, resulting in a fast capacity fade in sequent cycles. The formation of a lithium dendrite may also lead to safety incidents such as unexpected thermal run-a-way during recharging. The internal shorting would not only consume the energy but also generate a lot of heat. The overheating would decompose the electrolyte, leading to uncontrollable gassing, internal pressure build-up, and finally explosion of the battery.

Finally, while the ionic electrolytes are not flammable, they are highly corrosive and toxic. The electrolytes would cause environmental and health concerns if the batteries are vented or exploded by mishandling such as overheating, voltage reversal, or prolonged discharge on resistive loads. The concerns about toxicity of the inorganic electrolytes have been a main obstacle blocking the batteries from use in many civil applications.

With the increasing demand for portable devices, it is necessary to invent a new battery system that can overcome the limitations in battery chemistry and the economic barriers to wide-scale implementation of lithium ion batteries. There is an established need for rechargeable batteries that can be used in all kinds of applications like portable devices, power tools, electric vehicles, and even stationary systems. Current attempts to convert primary lithium ion battery technologies into secondary batteries possess numerous shortcomings and fail to live up to the advantages of their non-rechargeable counterparts. Therefore there is a need for a novel approach for a rechargeable battery system that is non-flammable, health-safe, environmentally-friendly, and cost-effective.

### SUMMARY OF THE INVENTION

The present invention is related to battery electrodes, electrolyte systems and battery making processes. Unlike the anode in the prior art, the anode in the present invention is not a lithium metal foil, but a composite comprising lithium ion intercalated in hosting compounds, such as graphite, amorphous carbons, and metal alloys. Employment of lithium ion intercalation materials in the anode would prevent lithium metal dendrite from forming during the recharge process. The lithium ions would be hosted in the crystal structure of the materials, rather than deposited on the geometric surface of a metallic lithium anode. Capacity of the anode would be greater than 320 Ah/kg.

The cathode in an embodiment of the present invention consists of lithium salts, lithium oxide, high surface area carbon black, and sometimes a catalyst. The lithium salts or lithium oxide in the cathode would provide reactants to the electrolyte system to form an ionic complex that will serve as both electrolyte and soluble cathode materials in sequent recycling. The soluble cathode would provide a specific capacity ranging from 300 to 700 Ah/kg.

The electrolyte in an embodiment of the present invention is a gel-forming polymer system. Liquid phase electrolyte is immobilized and hosted in a polymer matrix. Immobilization of liquid electrolyte by the polymer matrix would prevent the corrosive chemicals from leaking out of the battery when it was damaged by accident or abuse. This kind of electrolyte system would be leakage-proof even after the hermetic seal of the battery was broken, therefore, making such batteries environmental-friendly and safe.

The battery system in an embodiment of the present invention would have an open-circuit voltage (OCV) of 3.7-3.9V after recharging and a middle point voltage of 3.2-3.6V at a moderate C-rate during discharge. Gravimetric energy density and volumetric energy density of the batteries in the embodiment of the present invention are estimated at 250-400 Wh/kg and 450-900 Wh/L, respectively. These are significantly higher than that of the conventional lithium ion batteries, which have a gravimetric energy density of 150 Wh/kg and a 300 Wh/L volumetric energy density.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a cross-sectional view of the polymer-gel battery with stacked electrodes, according to an embodiment of the present invention.

FIG. 2 is an enlarged cross section of battery electrodes, polymeric matrix, ionic electrolyte, and separators seen in FIG. 1.

FIG. 3 is charge and discharge voltage curves of C/LiAlCl₄.6SO₂Cl₂/LiCl battery at 1C rate after 5 cycle conditioning according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

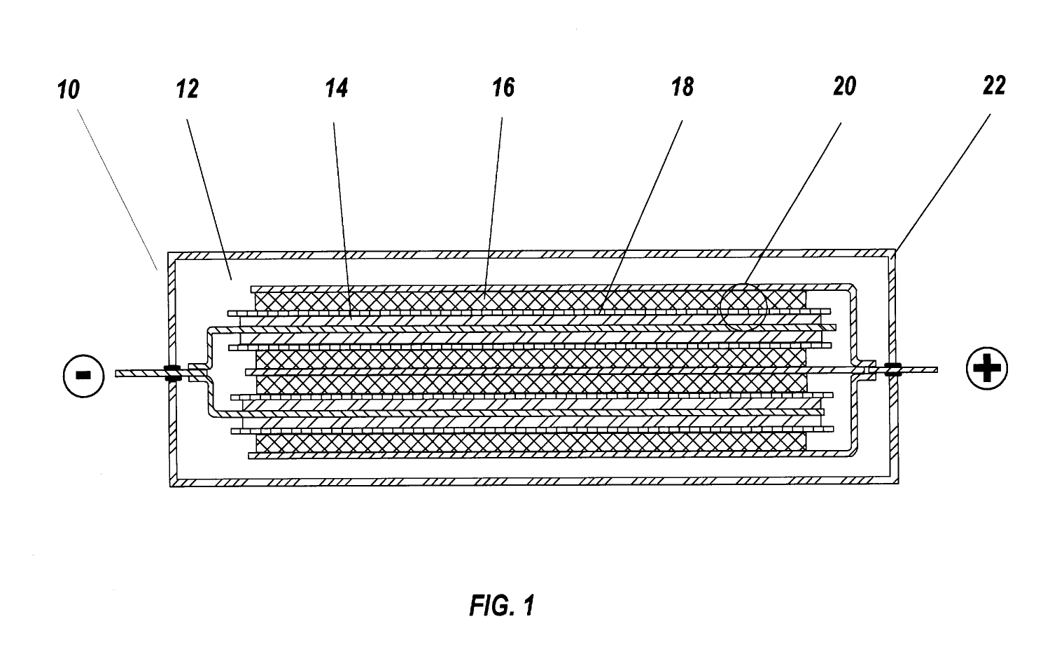

FIG. 1 depicts a battery 10 consisting of the battery cell 12 with stacked electrodes. The battery cell 12 comprises negative electrodes 14, positive electrodes 16, and an electrolyte-separator system 18 therebetween, and a stainless steel can 22 with gastight seal is used as a battery shell.

The negative electrode 14, normally called an anode, is a composite that may be fabricated by coating a mixture of slurry onto a metal foil or grid that acts as a substrate and current collector. Examples of possible metals for use as the metal substrate and current collector are nickel, stainless steel, or copper. The slurry comprises of active materials, polymeric binders, and conducting carbon black. The active materials may be one or a combination of lithium ion host materials such as carbon, petroleum coke, activated carbon, graphite, other carbonaceous materials like carbon fibers or graphite fibers, and metal alloys such as LiAl. The polymeric binders are fluoroethylene-based polymers such as polytetrafluoroethylene and ethylene-tetrafluoroethylene. In the preferred embodiment, the conducting carbon black are micro-particle powders with a surface area around 40 m²/g, such as Shawinigan Acetylene Black, Super P and Super S.

The positive electrode 16, referred to as a cathode, is also a composite fabricated by coating a mixture of slurry on an anti-corrosive and high-voltage stable metal foil or grid that acts as a substrate and current collector. Examples of possible metals for use as the metal substrate and current collector are nickel, stainless steel, or aluminum. The composite cathode slurry comprise of active materials, polymeric binders, conducting carbon black, and sometimes a catalyst. The active materials may be one or a combination of lithium metal salts or oxide such as LiCl, Li₂O, LiCoO₂, LiNiO₂, LiMn₂O₄ or doped solid solution Li_{α}Ni_{β}CO_{δ}M_{γ}O₂ (M=Mn, Al, Ti, Mg and Cr etc.). The theoretical capacity of the example active materials, in Ah/kg, is 632, 1795, 274, 275, 148, and ˜250 (depending on the chemical property and the amount of dopants in the solid solutions), respectively. The polymeric binders are fluoroethylene-based polymers such as polytetrafluoroethylene and ethylene-tetrafluoroethylene. In the preferred embodiment, the conducting carbon black are nano-particle powders with a surface area greater than 80 m²/g, such as Shawinigan Acetylene Black, Ketjen black carbon and Black pearls 2000. A further embodiment of the cathode includes a catalyst. The catalyst may be one or a combination of transition-metal oxides, such as V₂O₅, CoO₂, MnO₂, SnO₂, CuO, Cr₂O₃ and Fe₂O₃.

The polymer electrolyte-separator system 18 is a composite. Like anodic and cathodic composite electrodes, the polymer electrolyte-separator system 18 has a similar structure: active material hosted in a polymer matrix that is deposited as a layer on a microporous membrane substrate. Liquid active materials include solvent and lithium metal salts. The solvent may be a chloride, oxide or oxychloride of elements from periodic table groups VA, IVB and VIB. Examples of such solvents are SiCl₄, S₂Cl₂, SO₂, VCl₄, SOCl₂ and SO₂Cl₂. All of these chemicals are liquid at room temperature except for SO₂ that is a gas at room temperature and one atmosphere of pressure. However, SO₂ easily turns into liquid either at a slightly lower temperature or higher pressure in the presence of metal salts, such as LiCl.ALCl₃. These solvents directly participate in electrochemical reactions as reactants during charging and discharging. The chemical reactions will be later described in several example cells.

The lithium metal salts may be one or a combination of LiAlCl₄, LiGaCl₄, Li₂B₁₀Cl₁₀ and LiPF₆. These salts are highly soluble in oxychloride solvents. In comparison with an organic electrolyte, the ionic electrolyte offers three advantages: the first is high ionic conductivity, up to 1.1×10⁻¹S/cm; the second is high voltage stability, up to 5V versus lithium; and overcharge tolerance through a shuttle mechanism.

The polymer matrix may be made of fluoride-based, ethylene-based or silicon-based polymers, such as poly(vinylidene-fluoride), polyurethane, polyethylene-oxide, polyacrylate, polyacrylonitrile, polymethylacrylate, polyacrylamide, polyvinylacetate, polyvinylpyrrolidone, polyfluorosilicone, polyfluoropropylmethylsilicone, polyfluoropropylmethylcyclotetrasiloxane, polydimethylsiloxane, and polyepoxy. In some cases, the filler, such as fumed silica, alumina, or titania, is helpful for forming a gel-like and viscous electrolyte. A polymeric matrix serves as a host for liquid electrolyte that is allowed to come into contact with the two electrodes, but prevented from leaking out of the matrix. The microporous separator may be made from fluoropolymer, ethylenepolymer or copolymers, such Teflon® PTFE, Tefzel® ETFE, Vespel® polyimide, polymethylpentene, polypropylene, polyethylene or polyolefins. Inorganic fibers, such as glass mat or non-woven polymer sheets are also good materials for use in the separator.

The catalyst plays an important role in the battery system disclosed in an embodiment of the present invention. There are two kinds of catalysts, metal chloride in electrolyte solution and transition-metal oxides in the cathodic electrode. Thermodynamically, soluble cathodes are electrochemically rechargeable only by means of catalysts either in electrolyte solution or in the cathodic electrode.

In one embodiment of the present invention, a metal chloride such as AlCl₃ is used as a catalyst in the electrolyte solution containing SO₂. When LiCl is chosen as an active material in the cathode, which reacts with AlCl₃ during charge process to form AlCl₄⁻, it releases lithium ions. Then, two AlCl₄⁻ species transfer to two AlCl₃ by forming one chlorine Cl₂. Finally, the chlorine Cl₂ reacts with sulfur dioxide SO₂, forming sulfuryl chloride SO₂Cl₂, which is an energetic product of the charging process. The stored energy would then be released to outer electric loads during discharge process by shuttling lithium ions back to the cathode and dissociating SO₂Cl₂ into SO₂ and Cl₂, ending up with the formation of LiCl in the cathode. In this example, energy is stored in the format of lithium ions in the anode and SO₂Cl₂ in the electrolyte.

Another embodiment is the presence of a catalyst in the cathodic electrode. When lithium oxide is employed as active material in the cathode, a catalyst such as V₂O₅ would make lithium oxide soluble in the electrolyte as LiAlCl₄.SOCl₂ during the charge process. Under electrochemical charging condition, V₂O₅ first reacts with SOCl₂ in the electrolyte to form SO₂Cl₂, V₂O₅ itself being downgraded to V₂O₄. However, V₂O₄ is not a stable species and tends to attract oxygen and turns back to its original state. This triggers a dissociation of lithium oxide, Li₂O, into lithium ions and oxygen. The former dissolves into the electrolyte and the latter diffuses to the site of V₂O₄ for a recombination and regeneration to V₂O₅. The application of these possible catalysts will be discussed in the later examples.

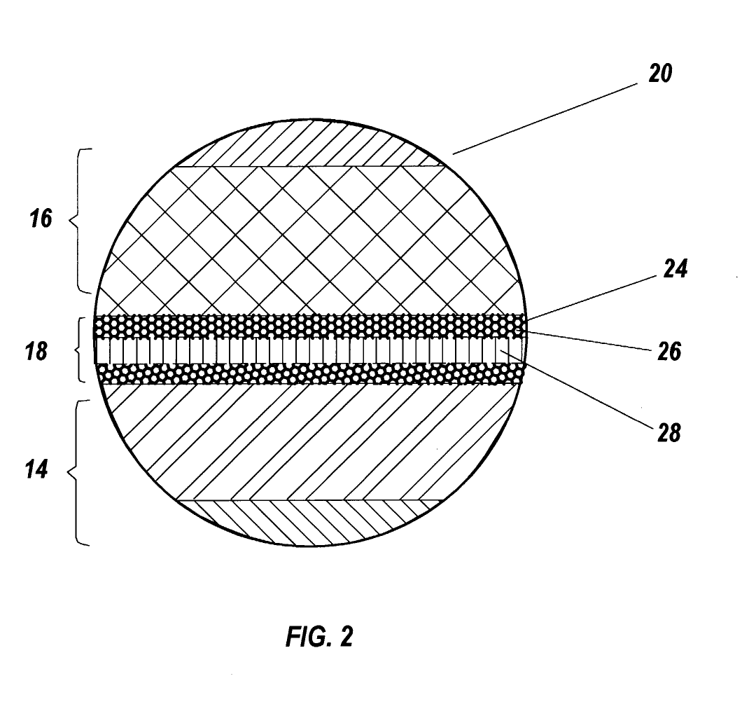

Referring now to the enlarged view 20 in FIG. 2, there is a polymer electrolyte-separator system 18 sandwiched between a composite anode 14 and a cathode 16. The polymer electrolyte-separator system 18 is also a composite layer comprising polymer matrix 24, liquid electrolyte 26, and separator 28. A polymer electrolyte-separator is a hybrid system with a liquid phase electrolyte inside a solid phase polymeric matrix, separator, and filler. The attachment of a liquid phase in, or on, a solid phase is due to physical absorption and chemical reaction. Both the polymeric matrix and separator membrane are highly porous, having a porosity ranging from 40% to 75%. The liquid electrolyte solution is physically absorbed and hosted in the pores. Another kind of reaction, a chemical reaction, may be involved between the polymer matrix and inorganic electrolyte. The electrolyte may react with polymer molecules by breaking their long chains. The polymer would then re-chain or regroup its molecules. The reaction would reach a kinetic equilibrium, resulting in forming a polymer-gel electrolyte. In the presence of filler, such as fumed silica, the inorganic electrolyte may have some degree of chemical reaction with the surface layer of the filler. The reaction would result in forming a particle-viscous electrolyte.

Two major chemical processes are involved in the battery system for the ionic electrolytes and soluble cathodes according to an embodiment of the present invention. They are the deintercalation/intercalation of lithium ions and catalyzed electrolysis/deposition of lithium compounds during the charge and discharge processes. The advantages of the battery system in this embodiment are higher energy density, higher power density and lower cost in comparison with the prior art battery systems.

The invention may be better understood using the following two examples.

### EXAMPLE 1

A 100 mAh stacked cell was built by overlaying electrodes and separators together, as shown in FIG. 1. The stacked cell is packed in a stainless steel can with gastight seals. The anode was fabricated by placing a slurry of 88% graphite (SLA1020 from Superior Graphite Co.), 10% ETFE (Tefzel from DuPont), and 2% Super S (from MMM) on a Ni mesh (3 Ni 5-4/0 Ni Exmet) current collector. The loading for this anode is 25 mg/cm². The cathode comprises a slurry of 45% LiCl (Fluka), 10% LiNi_{0.8}Co_{0.17}Al_{0.03}O₂ (CA2003 from Fuji Chemical), 37% carbon black (Shawinigan Acetylene Black), and 8% ETFE (Tefzel from DuPont) on a Ni mesh (3 Ni 5-4/0 Ni Exmet) current collector. The loading for the cathode is 26 mg/cm².

The liquid electrolyte is LiAlCl₄.6SO₂. The electrolyte was prepared by bubbling SO₂ gas through a mixture of LiCl and AlCl₃ at 20° C., until a strawcolored liquid was obtained. 3% excess AlCl₃ is then added into the electrolyte as a catalyst for the electrolysis of LiCl from the cathode into the electrolyte during the charge process. The separator is a microporous membrane (K857 from Celgard USA) and the polymer matrix is polydimethylsiloxane (from Dow Corning).

Like conventional rechargeable lithium ion batteries, the cells made according to the embodiment of the present invention need to be formed and activated by being charged at low C-rate before electrochemical duty cycling. Generally, the possible cell reactions for the present embodiment are as follows:

Charge mechanism:

The anode reaction: 2Li⁺+2e⁻=2Li

The cathode reaction: 2LiCl+2AlCl₃=2Li⁺+2AlCl₄⁻

2AlCl₄⁻=2AlCl₃+Cl₂+2e⁻

SO₂+Cl₂SO₂Cl₂

LiNi_{0.8}Co_{0.17}Al_{0.03}O₂=xLi⁺+Li₁₋ₓNi_{0.8}Co_{0.17}Al_{0.03}O₂+xe⁻

Discharge mechanism:

The anode reaction: 2Li=2Li⁺+2e⁻

The cathode reaction: SO₂Cl₂=SO₂+Cl₂

2Li⁺+Cl₂+2e⁻=2LiCl

xLi⁺+Li₁₋ₓNi_{0.8}Co_{0.17}Al_{0.03}O₂+xe⁻=LiNi_{0.8}Co_{0.17}Al_{0.03}O₂

Both the anode and cathode can be fabricated by coating their slurries on Ni grids and dried at 120° C. to eliminate coating solvent. Next, they are calendered to such a thickness that 30% porosity remains in the anode and 18% porosity in the cathode. Before battery assembly, both the anode and cathode are dried under vacuum at 120° C. to eliminate moisture. During each charge process, the dissoluble material, LiCl, would create additional porosity in the cathode. The total porosity after fully dissolving LiCl from the cathode into electrolyte is estimated as 40%. Non-dissoluble materials, such as LiNi_{0.8}Co_{0.17}Al_{0.03}O₂, Shawinigan Acetylene Black, and binder ETFE form the structural backbone of the cathode layer. Their occupation of the cathode is 55% by weight and 60% by volume because of their large surface areas. Among the non-dissoluble materials, the lithium intercalation compound LiNi_{0.8}Co_{0.17}Al_{0.03}O₂ serves as both the cathode electrode backbone and lithium ion host. Lithium ions would shuttle back and forth inside the crystal structure of the compound for deintercalation or intercalation. Shawinigan Acetylene Black serves as the cathodic electrode backbone, lithium chloride host, and conducting material. Lithium Chloride would dissolve from the surface of the Shawinigan Acetylene Black during charge and become deposited on the Shawinigan Acetylene Black during discharge.

There are two charging mechanisms in the cathode of the example battery: deintercalation of lithium ions from LiNi_{0.8}Co_{0.17}Al_{0.03}O₂ and electrolysis of lithium chloride under catalyst effect and electrochemical condition. The catalyst is AlCl₃ in the electrolyte solution, which reacts with LiCl to form AlCl₄⁻, dissolving lithium ions into the electrolyte. Then, two AlCl₄⁻ species transfer to two AlCl₃ by forming chlorine Cl₂. Finally, the chlorine Cl₂ reacts with sulfur dioxide SO₂, forming sulfuryl chloride SO₂Cl₂. During discharge, the process is reversed. The lithium ions shuttle back to the cathode and intercalate into the crystal structure of Li₁₋ₓNi_{0.8}Co_{0.17}Al_{0.03}O₂, as sulfuryl chloride SO₂Cl₂ reacts with lithium ions on the cathode surface to form sulfur dioxide in the electrolyte and to form lithium chloride in the cathode.

The capacities of the anode and cathode are estimated at 320 Ah/kg and 304 Ah/kg, respectively, with the calculations based on the total weight of each electrode, excluding the weight of the current collectors. The total cell capacity should be 103% higher than that of conventional lithium ion batteries using a C/LiCoO₂ system, whose cathode capacity is normally tested as 150 Ah/kg. As both dissolution of LiCl from the cathode and formation of SO₂Cl₂ in the electrolyte occur simultaneously during charge, the cell voltage profile during charge would be different from that of Li/LiAlCl₄.6SO₂/C cells, but similar to that of Li/SO₂Cl₂/C cells. At the end of the charge process, the electrolyte turns completely from LiAlCl₄.6SO₂ into LiAlCl₄.6SO₂Cl₂, and the discharge process will follow the mechanism proposed above.

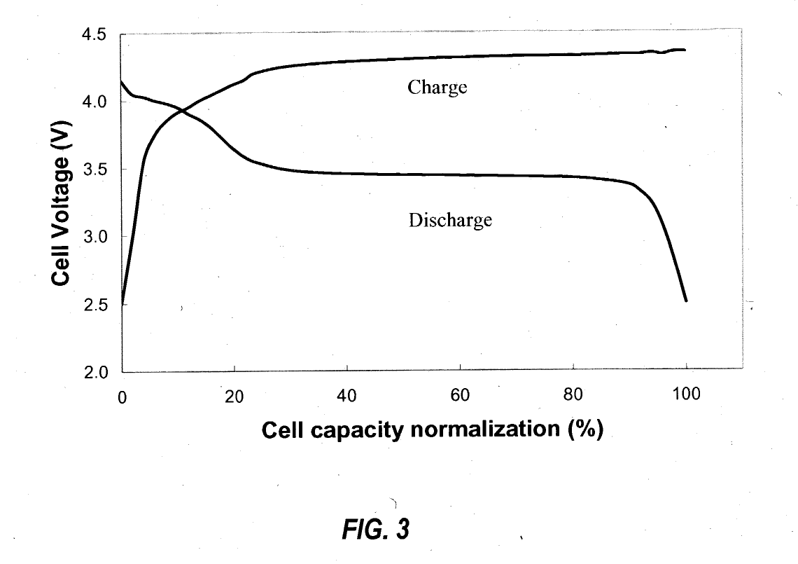

The cell voltage profiles at 1C rate for charge and discharge after 5 cycle conditioning are illustrated in FIG. 3. Two plateaus appear in the charging curve, the first one is located around 3.9V and the second around 4.3V. They correspond to two different charge mechanisms previously mentioned. Like the charge voltage profile, there are two voltage plateaus in the discharge voltage profile. The first has a middle point voltage at 3.8V, and the second at 3.4V.

### EXAMPLE 2

An 80 mAh jellyroll cell was built by winding electrodes/separators together. The jellyroll cell is packed in a stainless steel can with gastight seals. Compositions of the anode, cathode, and electrolyte/separator system are given below.

The anode is 90% graphite (Hitasol GP-EX51A from Hitachi Powdered Metal), 10% Polymer binder (Teflon® PTFE from DuPont), and the current collector is stainless steel mesh (3 SS 5-4/0 SS Exmet). Loading is 34 mg/cm². The Cathode is 40% Li₂O (from Aldrich), 20% V₂O₅ (from EM), 32% Ketjen black carbon, 8% Polymer binder (Teflon® PTFE from DuPont), and the current collector is stainless steel mesh (3 SS 5-4/0 SS Exmet). Loading is 18 mg/cm².

The liquid electrolyte is 1.5M LiAlCl₄.SOCl₂. The electrolyte was prepared by refluxing AlCl₃ and LiCl in SOCl₂ with 5% excess LiCl to insure neutralization of the AlCl₃. The separator is a microporous membrane (K857 from Celgard USA) and the polymer matrix is poly(vinylidene-fluoride) (from Atofina Chemicals).

The fresh cells need to be formed and activated before electrochemical duty cycling. Generally, the possible cell reactions for the embodiment are as follows:

Charge mechanism:

The anode reaction: 2Li⁺+2e⁻=2Li

The cathode reaction: SOCl₂+V₂O₅=SO₂Cl₂+V₂O₄

Li₂O=2Li⁺+½O₂+2e⁻

V₂O₄+½O₂=V₂O₅

Discharge mechanism:

The anode reaction: 2Li=2Li⁺+2e⁻

The cathode reaction: V₂O₅=V₂O₄+½O₂

2Li⁺+½O₂+2e⁻=Li₂O

SO₂Cl₂+V₂O₄=SOCl₂+V₂O₅

Both the anode and cathode can be fabricated by compressing their respective mixtures of powders on stainless steel grids. Then they are calendered to such a thickness that 30% porosity remains in the anode and 20% porosity in the cathode. Before battery assembly, both anode and cathode are dried, under vacuum, at 120° C. to eliminate moisture. During each charge process, the dissoluble material Li₂O would create additional porosity in the cathode. The total porosity, after fully dissolving Li₂O from the cathode into the electrolyte, is estimated as 45%. The structural backbone in the cathode layer is formed from the non-dissoluble materials V₂O₅, Ketjen black carbon, and a PTFE binder. Their occupation in the cathode is 60% by weight and 55% by volume. Among the non-dissoluble materials, the transition-metal oxide V₂O₅ serves as both cathodic electrode backbone and catalyst. Ketjen black carbon serves as a cathodic electrode backbone, lithium oxide substrate, and conducting material. Lithium oxide would dissolve from the surface of Ketjen black carbon during charge and be deposited during discharge. Unlike the charging mechanism described in the previous example, in which the battery charging catalyst AlCl₃ is dissolved in the electrolyte solution, the battery charging catalyst V₂O₅ in this example is located in the cathodic electrode layer. The cathode essentially does not get involved with the lithium ion intercalation mechanism in the present battery system. During a charge process, the solvent SOCl₂ would react first with the catalyst, V₂O₅, receiving oxygen and forming a double bond with sulfur. Therefore, thionyl chloride, SOCl₂, is converted into sulfuryl chloride, SO₂Cl₂, by degrading V₂O₅ to V₂O₄. However, V₂O₄ is a meta-stable species, having a tendency to turn itself back to stable state V₂O₅ by taking oxygen from lithium oxide. Under catalytic effect and an electrochemical environment, lithium oxide would be dissolved into the electrolyte by releasing oxygen to V₂O₅. The lithium ions travel from the cathode to the anode and intercalate into the crystal structure of the active anodic material. During discharge, the process is reversed. Lithium ions shuttle back to the cathode and take back oxygen from V₂O₅ being deposited on the surface of either V₂O₅ or Ketjen black carbon. Then V₂O₄ will be upgraded back to V₂O₅ by reacting with SO₂Cl₂.

The capacities of the anode and cathode are estimated as 330 Ah/kg and 716 Ah/kg, respectively, with calculation based on the total weight of each electrode, excluding the weight of the current collectors. The total cell capacity should be 3.7 times higher than that of conventional lithium ion batteries using a C/LiCoO₂ system, whose cathode capacity is normally calculated as 150 Ah/kg.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A secondary alkali metal-ion cell comprising:
a negative electrode element, the negative electrode element being a composite electrode, comprising an active material, a carbon black, a polymeric binder, and a current collector;
a positive electrode element, the positive electrode element being a composite electrode, comprising an active material, a carbon, a polymeric binder, a catalyst, and a current collector; and
a polymer electrolyte-separator-element, the polymer-electrolyte-separator element being a multi-layered system sandwiched between the negative and positive electrodes, comprising a polymeric matrix in which a liquid electrolyte is immobilized, a filler, a separator, and a catalyst.

2. The secondary alkali metal-ion cell according to claim 1, wherein the active material of the negative electrode element is selected from the group consisting of graphite, carbonaceous materials, petroleum coke, activated carbon, metal alloys, intermetallic compounds, and combinations thereof.

3. The secondary alkali metal-ion cell according to claim 1, wherein the polymeric binder of the negative electrode element is selected from the group consisting of polytetrafluoroethylene, ethylene-tetrafluoroethylene, polyimide, poly(vinylidene-fluoride), and combinations thereof.

4. The secondary alkali metal-ion cell according to claim 1, wherein the current collector of the negative electrode element is selected from the group consisting of copper, nickel, and stainless steel.

5. The secondary alkali metal-ion cell according to claim 1, wherein the active material of the positive electrode element is selected from the group consisting of lithium intercalation compounds, lithium salts, lithium oxides, and combinations thereof, wherein;
the lithium intercalation compound is selected from the group consisting of LiCoO₂, LiNiO₂, LiMn₂O₄ and doped solid solution Li_{α}Ni_{β}Co_{δ}M_{γ}O₂ where M is Mn, Al, Ti, Mg and Cr;
the lithium salt is selected from the group consisting of LiCl, Li₂S, LiF, Li₃P, Li₂P₅, Li₃N, Li₂CO₃, Li₂SO₄, LiNO₃, LiAlCl₄ and Li₃PO₄; and
the lithium oxide is selected from the group consisting of Li₂O, Li₂O₂ and LiOH.

6. The secondary alkali metal-ion cell according to claim 1, wherein the carbon of the positive electrode element is either amorphous or graphitized materials in the form of high surface area powders or fibers.

7. The secondary alkali metal-ion cell according to claim 1, wherein the polymeric binder of the positive electrode element is selected from the group consisting of polytetrafluoroethylene, ethylene-tetrafluoroethylene, polyimide, poly(vinylidene-fluoride), and combinations thereof.

8. The secondary alkali metal-ion cell according to claim 1, wherein the catalyst of the positive electrode element includes transition-metal oxides, such as V₂O₅, CoO₂, MnO₂, SnO₂, CuO, Cr₂O₃, and Fe₂O₃, and metal salts, such as AlCl₃.

9. The secondary alkali metal-ion cell according to claim 1, wherein the current collector of the positive electrode element is selected from the group consisting of nickel, stainless steel, and aluminum.

10. The secondary alkali metal-ion cell according to claim 1, wherein said polymer matrix is a porous layer of polymeric material selected from the group consisting of poly(vinylidene-fluoride), polyurethane, polyethylene-oxide, polyacrylate, polyacrylonitrile, polymethylacrylate, polyacrylamide, polyvinylacetate, polyvinylpyrrolidone, polyfluorosilicone, polyfluoropropylmethylsilicone, polyfluoropropylmethylcyclotetrasiloxane, polydimethylsiloxane, and polyepoxy.

11. The secondary alkali metal-ion cell according to claim 1, wherein said liquid electrolyte is an inorganic solution, comprising solvent and solvate wherein:
the solvent is selected from the group consisting of SiCl₄, S₂Cl₂, SCl₂, SO₂, VCl₄, SOCl₂, SO₂Cl₂, and combinations thereof; and
the solvate is selected from the group consisting of LiAlCl₄, LiGaCl₄, Li₂B₁₀Cl₁₀, LiPF₆, and combinations thereof.

12. The secondary alkali metal-ion cell according to claim 1, wherein said filler is high surface area particles, selecting from the group consisting of fumed silica, alumina and titania.

13. The secondary alkali metal-ion cell according to claim 1, wherein said separator is a microporous membrane made of polymers selecting from the group consisting of polytetrafluoroethylene, ethylene-tetrafluoroethylene, polyimide, polymethylpentene, polypropylene, polyethylene, and polyolefins.

14. The secondary alkali metal-ion cell according to claim 1, wherein said separator is a microporous mat or non-woven sheet made of glass fibers or polymeric fibers.

15. The secondary alkali metal-ion cell according to claim 1, wherein said catalyst is a chloride selected from the group consisting of BCl₃, AlCl₃, PCl₃, SCl₂, GaCl₃, and combinations thereof.

16. The secondary alkali metal-ion cell according to claim 1, wherein
said negative electrode element is a composite electrode, comprising 90% graphite active material, 10% polytetrafluoroethylene polymeric binder, and a stainless steel mesh current collector;
said positive electrode element is a composite electrode comprising 40% Li₂O and 20% V₂O₅ active material, 32% carbon black, 8%polytetrafluoroethylene polymeric binder, and a stainless steel mesh current collector; and
said polymer electrolyte-separator-element is a multi-layered system sandwiched between the negative and positive electrodes comprising a poly(vinylidene-fluoride) polymeric matrix, in which a LiAlCl₄.SOCl₂ liquid electrolyte is immobilized, and a microporous membrane separator

17. A rechargeable lithium stacked cell, comprising:
a negative electrode element, the negative electrode element being a composite electrode comprising 88% graphite active material, 2% Super S carbon black, 10% ethylene-tetrafluoroethylene polymeric binder, and a Ni mesh current collector;
a positive electrode element, the positive electrode element being a composite electrode comprising 45% LiCl and 10% LiNi_{0.8}Co_{0.17}Al_{0.03}O₂ active material, 37% carbon black, 8% ETFE polymeric binder, and a Ni mesh current collector; and
a polymer electrolyte-separator-element, the polymer electrolyte-separator-element being a multi-layered system sandwiched between the negative and positive electrodes comprising a polydimethylsiloxane polymeric matrix, in which a LiAlCl₄.6SO₂ liquid electrolyte is immobilized, a microporous membrane separator, and 3% AlCl₃ as a catalyst.

18. A method for making a secondary lithium-ion cell comprising the steps of:
positioning a cathode comprising lithium species intercalated in a carbon hosting compound opposite an anode comprising lithium ions intercalated in a carbon hosting compound; and
positioning a polymer-electrolyte-separator between the cathode and the anode wherein the polymer-electrolyte-separator comprises an inorganic liquid electrolyte immobilized in a hosting polymer matrix.
